(19) United States
(12) Patent Application Publication
(10) Pub. No.: US 2007/0031106 A1
(43) Pub. Date: Feb. 8, 2007

(54) Surface light source device and light guide using it and method therefor

(76) Inventors: Tomoyoshi Yamashita, Kanagawa (JP); Yoshiaki Murayama, Kanagawa (JP); Yoshihito Nozaki, Kanagawa (JP)

Correspondence Address: MORGAN LEWIS & BOCKIUS LLP, 1111 PENNSYLVANIA AVENUE NW, WASHINGTON, DC, 20004, US

(21) Appl. No.: 10/571,078

(22) PCT Filed: Sep. 9, 2004
(86) PCT No.: PCT/JP04/13099

§ 371 Date: Mar. 8, 2006

(30) Foreign Application Priority Data
Sep. 9, 2003 (JP) 2003-317291
Apr. 6, 2004 (JP) 2004-112127

(51) Int. Cl. G02B 6/10

(52) U.S. Cl. 385/146

(57) ABSTRACT

A planar light source device capable of preventing the occurrence of a luminescent line in the vicinity of a light incident end face without interrupting an incident light incoming from a primary light source and entering at a light incident end face, and being not likely to cause a decrease in incident light quantity, that is, without lowering entire luminance and producing dark lines to be caused when light to be originally guided is shaded. A platy light guide (3) that guides light emitted from a primary light source (1) and has a light incident end face (31) for receiving light from the primary light source (1) and a light emitting face (33) for outputting the guided light which is formed with a light absorption zone (36) extending along the light incident end face (31) and having a width of 50 to 1000 μm, and a side edge closer to the light incident end face (31) of the light absorption zone (36) is up to 300 μm away from the light incident end face (31). The light incident end face (31) is so constructed that light emitted from the primary light source (1) is incident as far as the boundary with the light emitting face (33).

### TECHNICAL FIELD

The present invention relates to a planar light source device of an edge-light type and a light guide for use in the light source device. More particularly, the invention relates to a planar light source device designed to reduce non-uniformity in luminance distribution observed as streaks, i.e., bright lines and/or dark lines, which exist near a light incident end face of a light guide facing a primary light source and which extend along the light incident end face of the light guide. The invention also relates to a light guide for use in the planar light source device and a method of manufacturing the light guide.

A planar light source device according to the present invention is fit for use as backlight in, for example, liquid crystal display devices.

### BACKGROUND ART

In recent years, liquid crystal display devices have been used widely in various fields, as monitors for portable notebook-type personal computers, display units of liquid crystal television receivers or video-integrated liquid crystal television receivers, and the like. A liquid crystal display device is basically constituted by a backlight unit and a liquid crystal display unit. In most cases, the backlight unit is of edge-light type. This is because the edge-light type helps to make the display device compact. The conventional backlight unit of edge-light type comprises a light guide shaped like a rectangular plate and a linear or rod-shaped primary light source. One end face of the light guide functions as a light incident end face. The primary light source is, for example, a linear fluorescent lamp and extends along the light incident end face of the light guide. The primary light source emits light, which is incident on the light incident end face to be introduced into the light guide and emitted from one of major surfaces of the light guide, i.e., a light emitting face.

In such a backlight, the luminance distribution in a light emission surface may not be uniform (that is, the luminance uniformity may decrease), due to the manner in which the light emitted from the primary light source travels in the light guide until it is emitted from the light guide. One mode of this decrease in luminance uniformity is the fact that the region of the light emission surface which is adjacent to the primary light source has higher luminance than the other regions.

Methods of preventing this decrease in luminance uniformity are disclosed in, for example, JP(Y)-40-26083 (Pat. Document 1), JP(U)-60-60788 (Pat. Document 2), and JP(U)-62-154422 (Pat. Document 3). In these techniques, a film that can absorb light or a ray-adjusting film that can suppress the passage of light is arranged on the region of the light emitting face of the light guide, which is close to the primary light source. These techniques are merely to restrict the light emission from the region of the light guide which is at a short distance from the primary source, because the light emitted from this region is more intense than the light emitted from the regions at longer distances from the primary source.

In recent years, light guides have become thinner (e.g., 2 to 3 mm). Consequently, the decrease in luminance uniformity may result in bright streaks (bright lines) that appear at a part of the light emission surface which corresponds to a part of the light emitting face of the light guide close to the light incident end face (for example, about 2 mm). The streaks are brighter than the other parts of the light emission surface and extend parallel to the light incident end face of the light guide. If such a technique as disclosed in Pat. Documents 1 to 3 is employed to prevent the decrease in luminance uniformity due to bright lines, not only bright lines and the parts surrounding these lines will decrease in luminance, but also dark lines will likely appear. This is because the light-absorbing film or the like formed has a large width.

A technique of preventing such a decrease in luminance uniformity due to bright lines has been proposed, as disclosed in, for example, JP(A)-9-197404 (Pat. Document 4). This technique lies in attaching a light shading member such as ink layer to the boundary between the light incident end face and light emitting face of the light guide and to the boundary between the light incident end face and the other surface of the light guide, which is opposite to the light emitting face.

As bright lines appear as described above, dark streaks (dark lines) may be observed between the bright lines. These streaks are darker than the surrounding and extend parallel to the light incident end face. JP(A)-8-227074 (Pat. Document 5) discloses a technique of preventing the generation of such dark lines. This technique uses a light absorption layer that has such a light absorption pattern that the light absorption rate gradually decreases as going away from the light incident end face.

Pat. Document 1: JP(Y)-40-26083

Pat. Document 2: JP(U)-60-60788

Pat. Document 3: JP(U)-62-154422

Pat. Document 4: JP(A)-9-197404

Pat. Document 5: JP(A)-8-227074

### DISCLOSURE OF INVENTION

The technique disclosed in Patent Document 4 resides in attaching a light shading member to an edge of the light incident end face of the light guide. Since a part of the light shading member covers the light incident end face, the light incident on the light incident end face is partly shaded so that the light introduced into the light guide from the primary light source decreases in amount by a value proportional to the size of the part covered by the light shading member. The entire luminance may therefore fall. Further, the part of the light incident on the light incident end face near the edge is shaded, though it would be introduced into and propagated through the light guide if the light shading member were not provided. Hence, dark lines are likely to appear in the display area. This technique which uses a light shading member having a very small width cannot sufficiently suppress the generation of bright lines. In practice, it is extremely difficult to attach a light shading member to the edge. It is difficult to form a light shading member at a desired position. Moreover, the light shading member, if attached to the edge, may easily be fall off.

In the technique disclosed in Patent Document 5, there is used a dotted pattern as the light absorption pattern. The light absorption layer therefore includes parts that do not absorb light. Thus, the light absorption layer can absorb the light, but insufficiently. Bright lines may inevitably be observed.

To solve the technical problems described above, according to the present invention there is provided a light guide for use in planar light source devices, which guides light emitted from a primary light source, comprising a light incident end face for receiving the light emitted from the primary light source; a light emitting face for emitting the light guided in the light guide; and a light absorption band or light absorption stripe or light absorption zone provided on the light emitting face, wherein the light absorption band extends along the light incident end face and has a width of 50 μm to 1000 μm, and an edge of the light absorption band which is positioned close to the light incident end face is at a distance of 300 μm or less from the light incident end face.

In an aspect of the present invention, the visible light transmittance of the light absorption band gradually increases from the side near the light incident end face toward the side remote from the light incident end face. In another aspect of the invention, the visible light transmittance of the light absorption band changes stepwise, at least two times, from the edge near the light incident end face toward the edge remote therefrom. In still another aspect of the invention, the visible light transmittance of the light absorption band continuously changes over at least one part, from the edge near the light incident end face toward the edge remote therefrom.

In an aspect of the present invention, the light absorption band has a minimum visible light transmittance falling within a range from 0% to 60% and a maaimum visible light transmittance falling within a range from 40% to 90%. In another aspect of this invention, the light absorption band is made of black paint. In still another aspect of the invention, the black paint is evaporation drying ink, thermosetting ink or ultraviolet-curable ink.

In an aspect of the present invention, the light absorption band contains light diffusing fine particles or light absorption fine particles. In another aspect of the invention, the light absorption band has minute convexes and minute concaves on a surface thereof. In a still another aspect of the invention, the minute projections on the surface of the light absorption band are formed by the light diffusing fine particles or light absorbing fine particles contained in the light absorption band.

In an aspect of the present invention, the edge part defining a boundary between the light emitting face and the light incident end face has a radius of curvature of 50 μm or less. In an aspect of the invention, the edge part defining a boundary between the light emitting face and the light incident end face is formed as a projection which extends along the light incident end face and projects relative to another region of the light emitting face, and the projection has a height of 1 to 50 μm as measured from the light emitting face and/or a full width at half maximum of the height of 1 to 50 μm.

In an aspect of the present invention, the side of the light absorption band, which is close to the light incident end face, is at a distance of 0 μm from the light incident end face. In another aspect of the invention, the light absorption band has a width of at most 0.4 times the thickness the light guide at a position of the light incident end face. In still another aspect of the invention, the light incident end face is configured so that the boundary with the light emitting face also receives light emitted from the primary light source.

In an aspect of the present invention, the light guide has a light emitting structure provided on the light emitting face and/or the back surface opposed to the light emitting face. In an aspect of the invention, the light emitting structure comprises a rough surface. In another aspect of the invention, the light emitting structure is provided on the light emitting face, and elongated prisms are arranged parallel to one another on the back surface in a direction intersecting substantially at right angles to the light incident end face. In still another aspect of this invention, each elongated prism has an apex angle of 85° to 110°. In another aspect of the invention, the light incident end face is roughened.

According to the present invention, there is provided a method of manufacturing a light guide for use in planar light source devices, comprising the steps of forming a light absorption band part (i.e., a portion corresponding to the light absorption band) on a light emitting face part (i.e., a portion corresponding to the light emitting face) of a light guide blank (i.e., a member to be made into the light guide) at least in a region adjacent to a light incident end face part (i.e., a portion corresponding to the light incident end face); and performing a shaving process on the light incident end face part, thereby forming the light incident end face.

In an aspect of the present invention, the edge part of the light absorption band part which is near the light incident end face part is also cut and removed during the shaving process. In an aspect of the present invention, the light absorption band part is formed by applying ink. In still another aspect of the invention, the light absorption band part is formed by ink-jet printing, screen printing, pad printing or tampo printing, or thermal transfer printing.

According to the present invention, there is provided a method of manufacturing a light guide for use in planar light source devices, comprising the steps of jetting ink from a plurality of nozzle by an ink jet printing method to form ink dots independent of one another or continuous in part to one another on a light emitting face of the light guide at least at a region adjacent to a light incident end face of the light guide; combining the ink dots which are close to one another, thereby forming a continuous ink layer on the entirety of the region; and curing the ink layer, thereby forming a light absorption band.

In an aspect of the present invention, the leveling time of the ink dots is adjusted, thereby controlling the coupling of the ink dots in the process of forming the ink layer. In another aspect of the invention, the coupling of the ink dots is adjusted to control the surface condition of the light absorption band. In a further aspect of the invention, the ink is an ultraviolet-curable black ink, and ultraviolet rays are applied to cure the ink layer. In still another aspect of this invention, a shaving process is carried out on a light incident end face part of the light guide blank, thereby forming the light incident end face, and the light absorption band is formed thereafter. In an aspect of the invention, the edge of the ink layer which is close to the light incident end face reaches a projection made during the shaving process and protruding from the light emitting face.

In an aspect of the present invention, the ink is ultraviolet-curable ink containing (meth)acrylate monomer and/or organic solvent. In another aspect of the invention, the (meth)acrylate monomer and/or organic solvent has a number average molecular weight of 100 or more. In a further aspect of the invention, the (meth)acrylate monomer is methyl methacrylate and/or is contained in the ink at an amount of 0.5 to 10% by weight. In still another aspect of the invention, the organic solvent has a boiling point of 60° C. or more and/or includes at least one element selected from the group consisting of methyl ethyl ketone, ethyl acetate, chloroform, cellosolve acetate and methacrylic acid.

Furthermore, according to the present invention, there is provided a planer light source device comprising the above light guide designed for use in planer light source devices; a primary light source arranged adjacent to the light incident end face of the light guide; and a light deflector element arranged adjacent to the light emitting face of the light guide, wherein the light deflector element has a light receiving surface and a light emitting surface opposed to the light receiving surface, and has a plurality of elongated prisms arranged on the light receiving surface and extending in parallel to one another and substantially in parallel to the light incident end face of the light guide.

In an aspect of the present invention, each of the elongated prisms provided on the light receiving surface of the light deflector element has two prism faces, and the light incident on one of the prism faces is totally reflected by the other of the prism faces. In another aspect of the invention, a light diffusing element is arranged adjacent to the light emitting surface of the light deflector element, the light diffusing element has a dot-pattern region on which a pattern of light absorption dots is provided, the dot-pattern region has a width within which are included two positions at a distance of 2 mm and another distance of 4 mm, respectively, from the light incident end face of the light guide, and the dot-pattern region has distributed dots of light absorption paint which have a diameter ranging from 30 μm to 70 μm. In a further aspect of the invention, the dot-pattern region of the optical deflection element has a visible light transmittance of 60% to 95%.

According to the present invention, a narrow light absorption band extending in parallel to the light incident end face of the light guide is provided on the light emitting face of the light guide and located near the light incident end face. Therefore, nothing shades or shields the light coming to the light incident end face from the primary light source. The light is introduced into the light guide from the primary light source with little loss. Hence, the overall luminance does not decrease or the light that should be introduced into the light guide is not shaded at all. No dark line will therefore be generated. Bright line or luminescent line or luminous line can be prevented from appearing in the vicinity of the light incident end face.

According to the present invention, the light absorption band is formed only on the light emitting face of the light guide. It is easier to form this band than otherwise. Moreover, the light absorption band thus formed hardly comes off. It can therefore prevent the generation of bright lines for a long time.

Furthermore, according to the present invention, a light absorption band part is formed on the light guide blank, and a shaving process is then performed on a light incident end face part of the light guide blank, thereby providing the light incident end face. This makes it easy to space the light absorption band by a distance of 0 μm from the light incident end face.

Still further, according to the present invention, ink dots are formed on the light emitting face of the light guide by means of ink-jet printing method. Thereafter, the ink dots are subjected to leveling and are thereby made larger. The ink dots are thereby combined with one another, forming a continuous ink layer. The ink-layer is cured, forming a light absorption band. Hence, the coupling of ink dots can be controlled by setting the leveling time in accordance with the viscosity of the ink. Thus, the surface condition of the light absorption band can be easily controlled.

### BRIEF DESCRIPTION OF THE DRAWINGS

FIG. 1 is a schematic perspective view showing an embodiment of a planar light source device according to the present invention;

FIG. 2 is a schematic plan view of a light guide and a primary light source;

FIG. 3 is a diagram for explaining an embodiment of a method of manufacturing a light guide according to the present invention;

FIG. 4 is a diagram for explaining an embodiment of a method of manufacturing a light guide according to the present invention;

FIG. 5 is a diagram showing how a light deflector element deflects a light;

FIG. 6 is a schematic plan view of a light diffusion element and a primary light source;

FIG. 7 is a schematic partial, cross-sectional view of a liquid crystal display device with a planar light source device according to the present invention used as a backlight;

FIG. 8 is a schematic partial, cross-sectional view of a light guide;

FIG. 9 is a schematic partial, cross-sectional view of a light guide;

FIG. 10 is a diagram showing a light guide and a visible light transmittance of a light absorption band;

FIG. 11 is a diagram showing a light guide and a visible light transmittance of a light absorption band;

FIG. 12A is a diagram for explaining an embodiment of a method of manufacturing the light guide;

FIG. 12B is a diagram for explaining an embodiment of a method of manufacturing the light guide;

FIG. 13A is a diagram for explaining an embodiment of a method of manufacturing the light guide;

FIG. 13B is a diagram for explaining an embodiment of a method of manufacturing the light guide;

FIG. 14A is a diagram for explaining an embodiment of a method of manufacturing the light guide;

FIG. 14B is a diagram for explaining an embodiment of a method of manufacturing the light guide;

FIG. 14C is a diagram for explaining an embodiment of a method of manufacturing the light guide;

FIG. 14D is a diagram for explaining an embodiment of a method of manufacturing the light guide;

FIG. 15 is a partial, cross-sectional view of a light guide;

FIG. 16 is an enlarged view of an edge portion of a light guide;

FIG. 17 is an enlarged view of an edge portion of a light guide; and

FIG. 18 is an enlarged view of an edge portion of a light guide,

wherein reference numeral 1 denotes a primary light source, 2 light source reflector, 3 light guide, 3′ light guide blank, 31 light incident end face, 31′ light incident end face part, 32 end face, 33 light emitting face, 33′ light emitting face part, 34 back surface, 36 light absorption band, 36-1 first region of light absorption band, 36-2 second region of light absorption band, 36A ink dot, 36B ink layer, 36′ light absorption band part, 37 convex, 38 light diffusing particle, 39 projection, 4 light deflector element, 41 light receiving surface, 42 light emitting surface, 5 light reflection element, 6 light diffusion element, 61 light incident surface, 62 light emitting surface, 64 dot pattern portion, 64′ light absorption paint dot, and 70 denotes a recess.

### BEST MODE FOR CARRYING OUT THE INVENTION

Embodiments of the present invention will be described, with reference to the accompanying drawings.

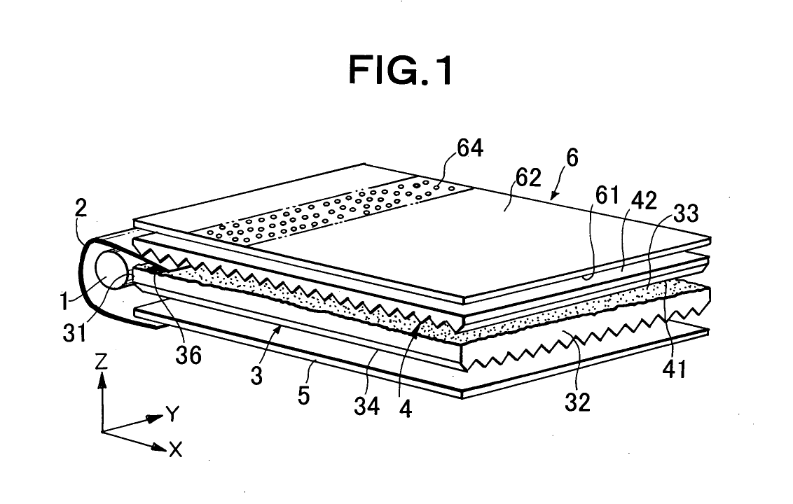

FIG. 1 is a schematic perspective view showing an embodiment of a planar light source device according to the present invention. As shown in FIG. 1, the planar light source device of the invention is constituted by: a light guide 3 having at least one end face used as a light incident end face 31, and at least one surface substantially perpendicular to the face 31 and used as light emitting face 33; a linear primary light source 1 opposed to the light incident end face 31 of the light guide 3 and covered with a light source reflector 2; a light deflector element 4 provided on the light emitting face of the light guide 3; a light diffusion element 6 provided on a light emitting surface 42 of the light deflector element 4 and facing it; and a light reflection element 5 provided so as to face a back surface 34 of the light guide 3, which is opposite to the light emitting face 33 of the light guide 3.

The light guide 3 is provided in parallel with the XY plane and shaped like a rectangular plate-as a whole. The light guide 3 has four side end faces. Of these side end faces, one of a pair that are parallel to the YZ plane is used as the light incident end face 31. The light incident end face 31 is provided so as to oppose the primary light source 1. Light emitted from the primary light source 1 enters into the light guide 3 through the light incident end face 31. In this invention, another light source may be provided so as to face, for example, the other side end face 32 that is opposite to the light incident end face 31.

Two major surfaces almost perpendicular to the light incident end face 31 of the light guide 3 are positioned substantially in parallel with the XY plane. One of the major surfaces (the upper one in the figure) is used as the light emitting face 33. On this light emitting face 33 or the back surface 34, or both, a directive light emitting structure composed of a rough surface is provided, or a directive light emitting structure is provided, which has a lens formed surface in which a number of elongated lens such as elongated prisms, elongated lenticular lenses, V-shaped grooves, or the like are formed. Thus, the light introduced into the light guide 3 through the light incident end face 31 is guided therein and emitted from the light emitting face 33 by the light emitting structure The light thus emitted has directivity in emission-light distribution in the plane (XZ plane) perpendicular to both the light incident end face 31 and the light emitting face 33. Angle α is defined between the light emitting face 33 and the direction of the peak (peak light) of the emission-light distribution in the XY plane. This angle α is, for example, 10 to 40 degrees, and for example, 10 to 40 degrees for the full width at half maximum of the emission-light distribution.

To improve the uniformity of luminance within the light emitting face 33, it is preferred that the rough surface or elongated lens formed on the surface of the light guide 3 should have an average inclination angle θa defined by ISO4287/1-1984, which ranges from 0.5 to 15 degrees. More preferably, the average inclination angle θa should range from 1 to 12 degrees. Much more preferably, the angle θa should range from 1.5 to 11 degrees. An optimal range for this average inclination angle θa should be set by the ratio (L/t) between thickness (t) of the light guide 3 and length (L) in the direction in which the incident light propagates. That is, if the light guide 3 has the ratio L/t of about 20 to 200, the average inclination angle θa should preferably be 0.5 to 7.5 degrees, more preferably be 1 to 5 degrees, and much more preferably be 1.5 to 4 degrees. If the light guide 3 has the ratio L/t of about 20 or less, the average inclination angle θa should preferably be 7 to 12 degrees and more preferably be in a range of 8 to 11 degrees.

The average inclination angle θa of the rough surface formed on the light guide 3 can be obtained according to ISO4287/1-1984, first by determining the shape of the rough surface with use of a surface roughness meter of stylus type, thus obtaining an inclination function f(x), and then by applying the function f(x) to the following equations (1) and (2):
Δa=(1/L)∫0^{L}|(d/dx)f(x)|dx (1)
θa=tan⁻¹(Δa) (2)
where x is the coordinate in the measuring direction, L is measured length, and Δa is a tangent of the average inclination angle θa.

The light guide 3 should preferably have a light emission rate which falls in a range of 0.5 to 5%, and more preferably in a range of 1 to 3%. If the light emission rate is less than 0.5%, the amount of light emitted from the light guide 3 will decrease, failing to provide sufficient luminance. If the light emission rate is greater than 5%, a large amount of light is emitted near the primary light source 1, and light will attenuate conspicuously in the X direction in the light emitting face 33. Consequently, the luminance uniformity tends to decrease in the light emitting face 33. If the light guide 3 has a light emission rate ranging from 0.5 to 5%, the angle of peak light in the emission-light distribution (in the XY plane) will fall within a range of 50 to 80 degrees. This also enables the light guide 3 to emit high-directivity light that has such emission characteristic that the full width at half maximum of the emission-light distribution (in the XY plane) ranges from 10 to 40 degrees. The light deflector element 4 can efficiently deflect the emission direction of the light. A planar light source device having high luminance can therefore be provided.

In the present invention, the light emission rate of light from the light guide 3 is defined as follows. The light intensity (I₀) of emitted light at an end edge of the light emitting face 33 on the light incident end face 31 side and the light intensity (I) at the position at a distance L from the end edge of the light emitting face 33 on the light incident end face 31 side satisfies the relationship given by the following equation (3):
I=I₀(A/100)[1−(α/100)]^{L/t} (3)
where t is the thickness of the light guide 3 (the size in the Z direction), constant α is the light emission rate that is indicated in percentage (%). At this emission rate, light is emitted per unit length (equivalent to the thickness t of the light guide) in the direction X perpendicular to the light incident end face 31, from the light guide 3. The light emission rate α can be obtained from a gradient that is found in plotting the relationship between a logarithm of the intensity of light emitted from the light emitting face 23 and the ratio (L/t) on the vertical axis and the horizontal axis, respectively.

On the other major surface that has no directive light emitting structure, a lens formed surface constituted by a number of elongated lens that extend in a direction (X direction) substantially vertical to the light incident end face 31 should be provided in order to control the directivity of the light emitted from the light guide 3 in the plane (i.e., the XY plane) that is parallel to the primary light source 1. In the embodiment shown in FIG. 1, the light emitting face 33 has a rough surface, and a lens formed surface is formed on the back surface 34. In the present invention, the lens formed surface consists of a number of elongated lenses extending in a direction substantially vertical (X direction) to the light incident end face 31. In this invention, a lens formed surface may be formed on the light emitting face 33, and the back surface 34 may be a rough surface, in contrast to the embedment of FIG. 1.

Elongated lenses formed on the back surface 34 or light emitting face 33 of the light guide 3 as illustrated in FIG. 1 may be elongated prisms, elongated lenticular lenses, or V-shaped grooves, which extend substantially in the X direction. Of these, elongated prisms each having a cross section substantially triangular in the YZ plane are preferable.

In this invention, elongated prisms formed on the back surface 34 of the light guide 3 should preferably have an apex angle ranging from 85 to 110 degrees. If the apex angle falls within this range, the light emitted from the light guide 3 can be appropriately condensed, enhancing the luminance of the planer light source device. More preferably, the apex angle should range from 90 to 100 degrees.

In a light guide according to this invention, each elongated prism may have a flat or curved part at the top, in order to form a desirable shape of the elongated prisms at high precision to acquire stable optical characteristic and in order not to be worn or deformed while being assembled or used in the light source device.

In the present invention, it is possible to form a directive light emitting structure by mixing and dispersing fine light-diffusive particles inside the light guide, in place of or in addition to the light emitting structure provided on the light emitting face 33 or back surface 34 as described above.

To adjust the spread of the light in the XY plane and/or the XZ pane, the light incident end face 31 should preferably be roughened. It may be roughened by various methods, e.g., by shaving it with a milling machine, polishing it with a grindstone, sandpaper, a buff or the like, or by subjecting it to blast polishing, electrical discharging machining, electrolytic polishing, chemical polishing or a similar process. The blast particles used in the blast polishing may be spherical ones such as glass beads, or polygonal ones such as alumina beads. Polygonal blast particles are preferable, because they can form rough surfaces which have better effect to spread the light. Anisotropic rough surfaces can be formed if the direction of shaving or polishing is adjusted. To adjust the spread of light in the XY plane, the process may proceed in the Z direction. In this case, grooves and ridges can be made in the form of streaks extending in the Z direction. To adjust the spread of light in the XZ plane, the process may proceed in the Y direction. Then, grooves and ridges can be made in the form of-streaks extending in the Y direction. This process of roughening can be applied directly to the light incident end face of the light guide. Instead, the part of a mold, which corresponds to the light incident end face, may be processed, and transferred to the light incident end face of the light guide in the molding process.

The light incident end face 31 is preferably be roughened regarding the thickness direction of the light guide to the extent of an average inclination angle θa of 1 to 5 degrees, a centerline-average roughness Ra of 0.05 to 0.5 μm and a 10-point-average roughness Rz of 0.5 to 3 μm. If the light incident end face 31 is so roughened, the generation of bright areas of stripe shape and dark areas of stripe shape can be suppressed, and the bright lines and the dark lines can be blurred and made to be hardly visible. The average inclination angle θa is more preferably 2 to 4.5 degrees, and much more preferably 2.5 to 3 degrees. The centerline-average roughness Ra is more preferably 0.07 to 0.3 μm, and still more preferably 0.1 to 0.25 μm. The 10-point-average roughness Rz is more preferably 0.7 to 2.5 μm, and even more preferably 1 to 2 μm. For the same reason as mentioned above, it is desired that the light incident end face 31 be roughened regarding the lengthwise direction of the light incident end face to the extent of an average inclination angle θa of 1 to 3 degrees, a centerline-average roughness Ra of 0.02 to 0.1 μm and a 10-point-average roughness Rz of 0.3 to 2 μm. The average inclination angle θa is more preferably 1.3 to 2.7 degrees, and much more preferably 1.5 to 2.5 degrees; the centerline-average roughness Ra is more preferably 0.03 to 0.08 μm, and still more preferably 0.05 to 0.07 μm; the 10-point-average roughness Rz is more preferably 0.4 to 1.7 μm, and even more preferably 0.5 to 1.5 μm.

A light absorption band 36 is formed on the light emitting face 33 of the light guide and extends along the light incident end face 31. The light absorption band 36 can be provided by coating with, for example, black paint. The method of forming the light absorption band 36 is not limited to this, nonetheless. The band 36 may be formed by coating with ink. Preferably, the band 36 is formed by means of ink jet printing or screen printing, pad or tampo printing, or thermal transfer printing. In view of productivity, the light absorption band 36 is preferably made of material that can dry fast. The material should preferably dry within 60 seconds, more preferably within 40 seconds, and still more preferably within 20 seconds, after it has been applied. The material is, for example, paint based on organic solvent such as ethyl methyl ketone or on methacrylate monomer; evaporation drying ink; thermosetting ink; or ultraviolet-curable paint or ink. The light absorption band absorbs at least part of the light introduced into the light guide 3 directly through the light incident end face 31, preventing bright lines from being generated in the vicinity of the light incident end face 31. Therefore, it should preferably have visible light transmittance (JIS-K7105B) of, for example, 0 to 90%, preferably 0 to 60%, more preferably 2 to 45%, and still more preferably 4 to 30%. The light absorption band 36 preferably has reflectance (JIS-K7105B) of 0 to 20%, and more preferably reflectance of 0 to 15%. Incidentally, the light entering the light guide through the light emitting face 33 after it is reflected by the light source reflector 2 is considered to contribute to the generation of bright lines. The light absorption band 36 absorbs part of such light too, and thus prevents the generation of bright lines.

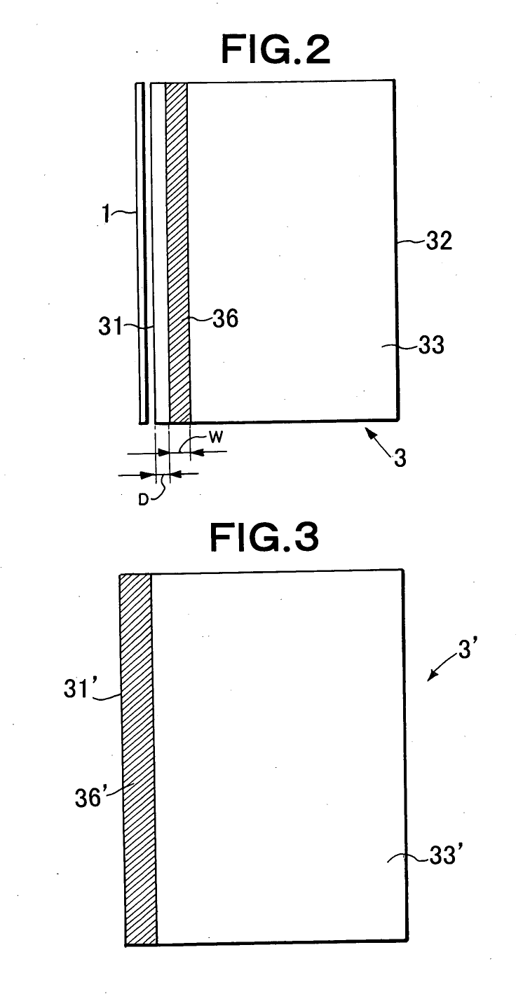

FIG. 2 is a plan view that schematically shows the light guide 3, together with the primary light source 1. As seen from FIG. 2, the light absorption band 36 must be formed on the light emitting face 33 only, not on the light incident end face 31. Thus, it does not shade the light incident on the light incident end face 31, preventing decrease in luminance due to a small amount of light introduced into the light guide, and preventing dark lines from being generated when the light to be transmitted is shaded. The light absorption band 36 has width W (measured in the X direction) defined by two edges. Of these edges, the one close to the light incident end face 31 is located at distance D from the light incident end face 31. Width W is preferably 50 to 1000 μm, more preferably 100 to 700 μm, and much more preferably 200 to 400 μm. If width W is less than 50 μm, the generation of bright lines will not be prevented as desired. If width W exceeds 1000 μm, dark lines will be generated or the decrease in luminance will be generated as a whole. Width W is preferably at most 0.4 times the thickness that the light guide 3 has at its light incident end face, more preferably at most 0.3 times the thickness, and much more preferably at most 0.2 times the thickness. If distance D is 300 μm or less, the generation of bright lines can be prevented. Distance D should be preferably 200 μm or less, and more preferably 100 μm or less.

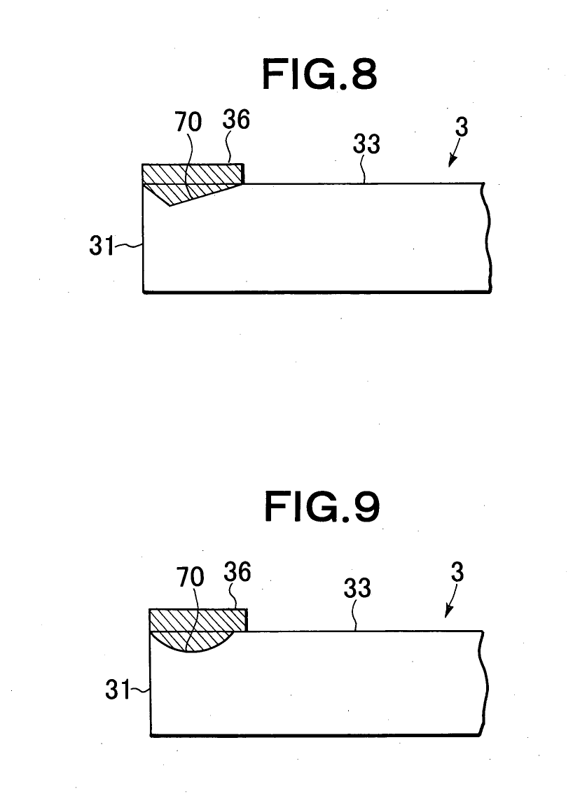

To form the light absorption band 36 on the light emitting face 33 of the light guide 3, a recess is made in at least one part of the region of light emitting face 33, on which the light absorption band 36 is to be provided, by applying the paint or the like on the recess. That is, as shown in FIG. 8 and FIG. 9, a recess 70 having, for example, a lenticular-shaped cross section or a triangular cross section is made in the light emitting face 33 to a thickness of, for example, 150 μm or less, preferably 100 μm or less, and much more preferably 50 μm or less. Then, the light absorption band 36 is formed in the recess thus made. If the recess 70 is too large, the light-guiding mode will not be completely attained in the light guide and dark lines will likely appear.

The shape of the light guide 3 is not limited to the one depicted in FIG. 1. The light guide 3 may be shaped like a wedge, being thicker on the light incident end face side.

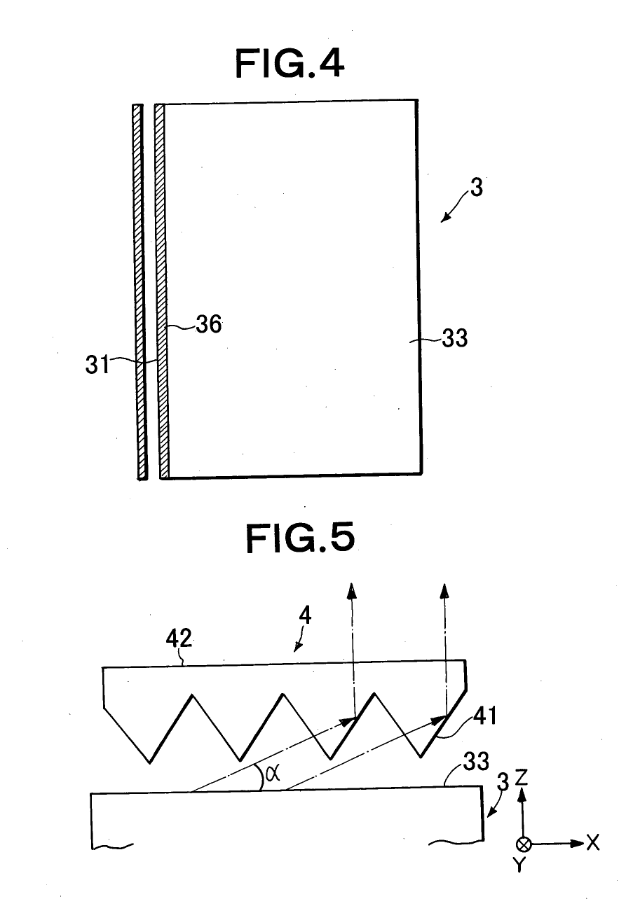

A method of manufacturing the light guide thus configured will be described, with reference to FIG. 3 and FIG. 4.

FIG. 3 is a schematic plan view depicting a light guide blank 3′ made by resin molding process and coated with a paint layer that will be processed into a light absorption band. The light guide blank 3′ has a light incident end face part 31′, a light emitting face part 33′, and a light absorption band part 36′. These parts 31′, 33′ and 36′ correspond to the light incident end face 31, the light emitting face 33, and the light absorption band 36, respectively. The light emitting face part 33′ has a mat-finished surface, which is a rough surface that constitutes a light emitting structure. On the back surface that faces away from the mat-finished surface, elongated prisms are formed. The light absorption band part 36′ is formed on the region of the light absorption band part 36′ which is adjacent to the light incident end face part 31′.

As FIG. 4 shows, a shaving process is performed on the light incident end face part 31′, removing an unnecessary part thereof. The light incident end face 31 is thereby provided as a shaving process face. The light emitted from the primary light source 1 can therefore be easily incident on the light incident end face 31 up to the boundary with the light emitting face 33. As is illustrated in FIG. 3 and FIG. 4, the light absorption band part 31′ is formed even on the unnecessary part to be removed in the shaving process, and the edge part of light absorption band part 31′ close to the light incident end face part 31′ is cut and removed in the shaving process. Thus, the above-mentioned distance D is set to 0 μm, whereby the light emitted from the primary light source 1 can be easily incident on the light incident end face 31 up to the boundary with the light emitting face 33.

The light deflector element 4 is arranged on the light emitting face 33 of the light guide 3. The light deflector element 4 has two major or principal surfaces 41 and 42 that are parallel to each other. Both major surfaces 41 and 42 extend in parallel to the XY plane. One of the major surfaces 41 and 42 (i.e., the major surface positioned on the light emitting face 33 side of the light guide 3) is a light receiving surface 41. The other major surface is a light emitting surface 42. The light emitting surface 42 is a flat surface that is parallel to the light emitting face 33 of the light guide 3. The light receiving surface 41 is an elongated prism formed surface on which elongated prisms are formed. Namely, a number of elongated prisms are provided, which extend in the Y direction, parallel to one another. The elongated prisms may be spaced apart to provide relatively narrow flat regions between them (each flat region being as broad as, or narrower than, the prism width measured in the X direction). To enhance the use efficiency of light, however, it is desired that the elongated prisms be arranged side by side, without providing flat regions between them.

FIG. 5 shows how the light deflector element 4 deflects the light it has received. This figure illustrates the direction in which the peak light (i.e., light having a peak of the emitted light distribution) emitted from the light guide 3 travels in the XZ plane. The peak light emitted from the light emitting face 33 of the light guide 3, obliquely at an angle α. This light enters the first faces of the elongated prisms, totally reflected by the second faces thereof, and emitted from the prisms in a direction that is almost a normal to the light emitting surface 42. In the YZ plane, the elongated prisms provided on the back surface 34 of the light guide can sufficiently enhance the luminance along the normal to the light emitting surface 42 in a broad region.

The faces of each elongated prism of the light deflector element 4 is not limited to a flat one. It may have a convex polygonal cross section or a convex curved cross section. This helps to increase the luminance and narrow the view field.

In the light deflector element according to this invention, the elongated prism may have a flat top portion or a curved top portion, in order to form a desired prism shape with high precision to achieve stable optical characteristics, and in order to suppress wearing and deformation of the top portion during the assembling of the light source device and during the use thereof. In this case, it is desired that the flat or curved top portion should have a width of 3 μm or less, in order to prevent a decrease in luminance of the light source device and generation of a non-uniform pattern in luminance due to sticking phenomenon. The width of the top portion is 2 μm or less, and more preferably 1 μm or less.

In the present invention, the light diffusion element 6 can be arranged on the light emitting surface 42 of the light deflector element 4, if necessary, so that the size of the view field may be controlled, while suppressing the luminance reduction as mush as possible. Since the light diffusion element 6 is so arranged, it is possible to suppress generation of glaring, bright spots, and the like, which degrade the product quality. Thus, the product quality can be enhanced.

It is desirable to add a concave/convex structure to a light incident surface 61 of the light diffusion element 6 opposed to the light deflector element 4 in order to prevent the surface 61 from sticking to the light deflector element 4. Similarly, a concave/convex structure should be added to a light emitting surface 62 of the light diffusion element 6 too, in order to prevent the surface 62 from sticking to the liquid crystal display element arranged above the light diffusion element 6. For the purpose of preventing generation of sticking only, the concave/convex structure should be designed to have-an average inclination angle of 0.7 degrees or more. The average inclination angle is preferably 1 degree or more, and more preferably 1.5 degrees or more.

The light diffusion element 6 can acquire light-diffusion characteristic if it contains light diffusion material or has a concave/convex structure on at least one surface. The light diffusion material may consist of, for example, homopolymer or copolymer of silicone beads, polystyrene, polymethyl methacrylate, fluorinated methacrylate, or the like. The concave/convex structure differs in average inclination angle, depending on whether it is provided on only one surface of the element 6 or on both surfaces thereof. If the light diffusion element 6 has a concave/convex structure on one surface only, the average inclination angle of the surface preferably ranges from 0.8 to 12 degrees, more preferably 3.5 to 7 degrees, and sill more preferably 4 to 6.5 degrees. If the light diffusion element 6 has concave/convex structures on both surfaces, the average inclination angle of one surface preferably ranges from 0.8 to 6 degrees, more preferably 2 to 4 degrees, and sill more preferably 2.5 to 4 degrees. If this is the case, it is desired that the average inclination angle of the light incident surface of the light diffusion element 6 be greater than the average inclination angle of the light emitting surface thereof.

From the view point of improving the luminance characteristic and visibility, the haze value of the light diffusion element 6 should preferably be within a range of 8 to 82%, more preferably within a range of 30 to 70%, and much more preferably within a range of 40 to 65%.

FIG. 6 is a schematic plan view of the light diffusion element 6, showing the primary light source 1 too. As seen from FIGS. 1 and 6, the light diffusion element 6 has a dot pattern portion 64. The dot pattern portion 64 consists of distributed dots of light absorption paint. These layers are arranged and dispersed on the light emitting surface 62, each having a diameter of 30 μm to 70 μm. They exist in a region that has a width (d2−d1), where d1 and d2 are distances from the light incident end face of the light guide. Distances d1 and d2 should be preferably 2 mm or less and 4 mm or larger, respectively. Then, the brightness near the primary light source can be appropriately suppressed, thereby imparting a natural luminance distribution to the light emitting surface. To achieve this efficiently, it is desired that the dot pattern portion 64 should have visible light transmittance ranging from 60% to 95%. In order to irmpart a more natural luminance distribution to the light emitting surface, it is desired that the distributed dots of light absorption paint be arranged in a density that gradually decreases away from the primary light source, at least in a region close to a point at distance d2 from the light incident end face.

The primary light source 1 is a rod-shaped light source that extends in the Y direction. It can be, for example, a fluorescent lamp or a cold-cathode tube. In addition to the primary light source 1 arranged at the end face of the light guide 3 as illustrated in FIG. 1, an additional primary light source may be provided, if necessary, at the other end face of the light guide 3. In the present invention, the primary light source 1 is not limited to a linear light source. Rather, it can be a spot light source such as an LED light source, a halogen lamp, a metal halide lamp, or the like. Of these spot light sources, the LED, which is small, is particularly desirable in the small-screen displays for use in cellular phones or personal digital assistants. If spot light sources are used as-primary light sources 1, they may be provided at the corners of the light guide 3. In this case, the light introduced into the light guide 3 travels in the light guide in the radial direction of each primary source 1 in the plane along the light emitting face. Hence, a number of elongated lenses should be arranged in an arc on the light emitting face of the light guide 3 and should surround the spot light sources, thereby forming the light emitting structure. Then, the luminance uniformity can be enhanced. The light emitted from the light emitting face of the light guide 3 also travel in the radial direction of each primary source 1 in the plane along the light emitting face. Accordingly, in order to deflect such a light effectively in a desired direction, the elongated prisms formed on the light deflector element 4 should preferably be arranged in an arc to surround the primary light source 1. If so arranged, the elongated prisms will cause increase in luminance uniformity.

The light source reflector 2 guides light from the primary light source 1 to the light guide 3 with little loss. As material of the reflector 2, for example, a plastic film having a metal-deposited reflection layer on the surface thereof can be used. As shown in the figure, the light source reflector 2 is wound around the edge of the light emitting face of the light guide 3 after extending from the edge of the light reflection element 5 over the outer face of the primary light source 1, avoiding the light diffusion element 6 and the light deflector element 4. Otherwise, the light source reflector 2 can be wound around the edge of the light emitting surface of the light deflector element 4 after extending from the edge of the light reflection element 5 over the outer surface of the primary light source 1, avoiding the light diffusion element 6 only. Alternatively, it can be wound around the edge of the light emitting surface of the light diffusion element 6, after extending from the edge of the light reflection element 5 over the outer face of the primary light source 1.

A reflecting member similar to the light source reflector 2 may be provided on the end faces other than the light incident end face 31 of the light guide 3. The light reflection element 5 can be, for example, a plastic sheet that has a metal-deposited reflection layer on its one surface. In the present invention, the light reflection element 5 can be replaced by a light-reflecting layer or the like that is formed by vapor-depositing metal on the back surface 34 of the light guide 3.

In the present invention, the light guide 3, light deflector element 4 and light diffusion element 6 can be made of synthetic resin having a high light transmittance. Examples of this kind of synthetic resin are methacrylic resin, acrylic resin, polycarbonate resin, polyester resin, and vinyl chloride resin. In particular, methacrylic resin has a high light transmittance and is excellent in heat resistance, physical characteristics, and molding-processability and is therefore most suitable. Methacrylic resin of this kind contains methyl methacrylate as major copponent. It should preferably contain 80 wt % or more of methyl methacrylate. To form the surface structures of rough surfaces or hair lines of the light guide 3, the light deflector element 4 and the light diffusion element 6 or the surface structure of the elongated prisms, elongated lenticular lenses or the like thereof, a transparent synthetic-resin plate may be hot-pressed with a mold member that has a surface structure desired. At the same time the molding is performed, shaping may be carried out by screen printing, extrusion molding, injection molding, or the like. In addition, a structural surface may be formed by use of heat- or light-curable resin. Further, a rough surface structure or an elongated lens structure may be formed of active energy curable resin, on the surface of a transparent base such as a transparent film or sheet made of polyester resin, acrylic resin, polycarbonate resin, vinyl chloride resin, polymethacrylimide resin, or the like. Such a sheet may be jointed to and integrated with another transparent base member by a method of adhesion, fusion bond, or the like. As the active energy curable resin, a multifunctional (meth)acrylic compound, vinyl compound, (meth)acrylic esters, allyl compound, metal salt of (meth)acrylic acid, or the like may be used.

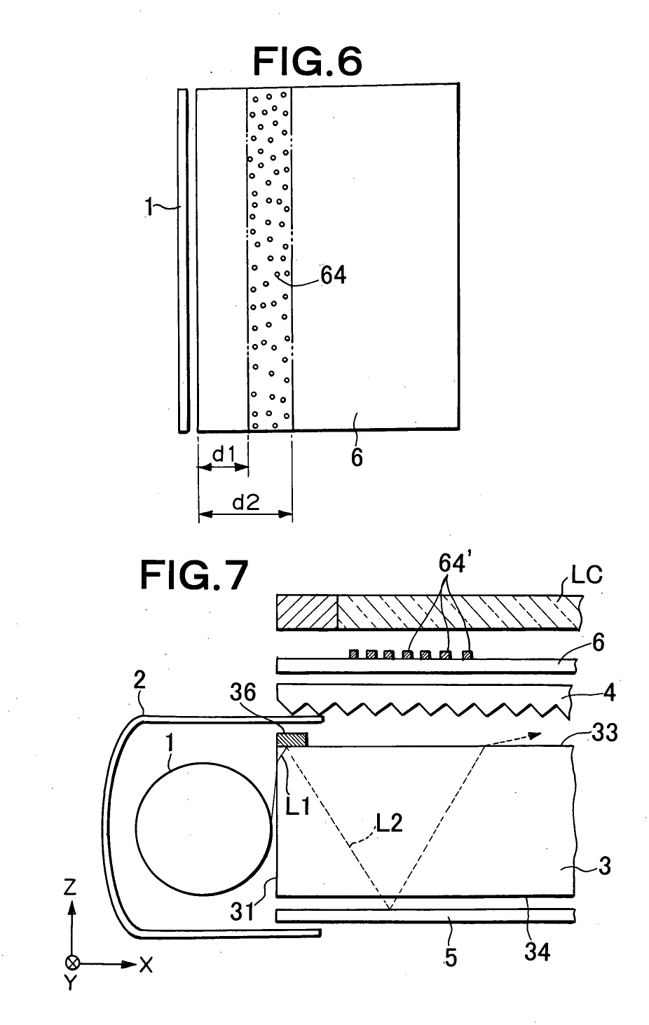

A liquid crystal display element LC as shown in FIG. 7 is arranged on the light emitting surface (i.e., the light emitting surface 62 of light diffusion element 6) of the light source device that comprises the primary light source 1, light source reflector 2, light guide 3, light deflector element 4, light diffusion element 6 and light reflection element 5. Thus, a liquid crystal display device is provided, which uses the light source device according to this invention as a backlight. In FIG. 7, the reference number 64′ indicates the light absorption paint dots constituting the dot pattern portion of the light diffusion element 6. The liquid crystal display device is observed from above the liquid crystal display element LC (FIG. 7).

FIG. 7 illustrates the case where the above-mentioned distance D is set to 0 μm. As shown in FIG. 7, the light absorption band 36 extends to the boundary with the light incident end face 31, but not to the light incident end face 31. That is, the light incident end face 31 is configured so that the light emitted from the primary light source 1 may reach the light incident end face 31 as well as the boundary with the light emitting face 33.

Of the light introduced into the light guide 3 via the light incident end face 31, light L1 that has directly reached the light absorption band 36 is absorbed in greater part into the light absorption band described above. The remaining part of the light is reflected at the light emitting face 33 and travels, as light L2, through the light guide. Light L2 is emitted from the back surface 34, reflected by the light reflection element 5, then enters the light guide again to be emitted from the light emitting face 33. In the present invention, light L2 is less intense than light L1, because the light absorption band 36 has absorbed greater part of the latter. Hence, it would not generate bright lines. Without the light absorption band 36, light L2 would be considerably intense. Light L2, i.e., the light reflected by the light absorption band 36, is the main cause of bright lines. If the band 36 were not provided, conspicuous bright line should be generated.

The light source reflector 22 reflects part of the light emitted from the primary light source 1. The light thus reflected reaches the light absorption band 36, without reaching the light incident end face 31. Most of the light is absorbed in the band 36. If the light absorption band 36 were not provided, light should enter the light guide via the part of the light emitting face 33, on which the band 36 should be laid. This light would result in bright lines if the light absorption band 36 were not provided on the light emitting face 33.

In the present invention, light fully collimated and thus having a narrow luminance distribution (in the XZ plane) can be directed from the light source device to the liquid crystal display element LC. Therefore, no inversion of gradation will occur in the liquid crystal display element. The display device can therefore display images having good hue uniformity. In addition, light can be condensed in the desired direction. In this direction, the light emitted from the primary light source 1 is used at high efficiency for illumination with respect to this direction.

In the above description of the embodiment, the light absorption band 36 has been described as one that absorbs light almost uniformly in the widthwise direction. However, a light absorption band may be used in this invention, which has light absorption characteristic that varies in the widthwise direction. A light absorption band exhibiting such a light absorption characteristic may preferably have visible light transmittance that gradually increases from the edge close to the light incident end face to the edge remote from the light incident end face of the band 36. If this light absorption band is used, the light absorption at the boundary between the light absorption band 36 and the region of the light emitting face 33 which is not covered with the band 36 is prevented from changing abruptly. This more reduces the possibility of bright-line generation.

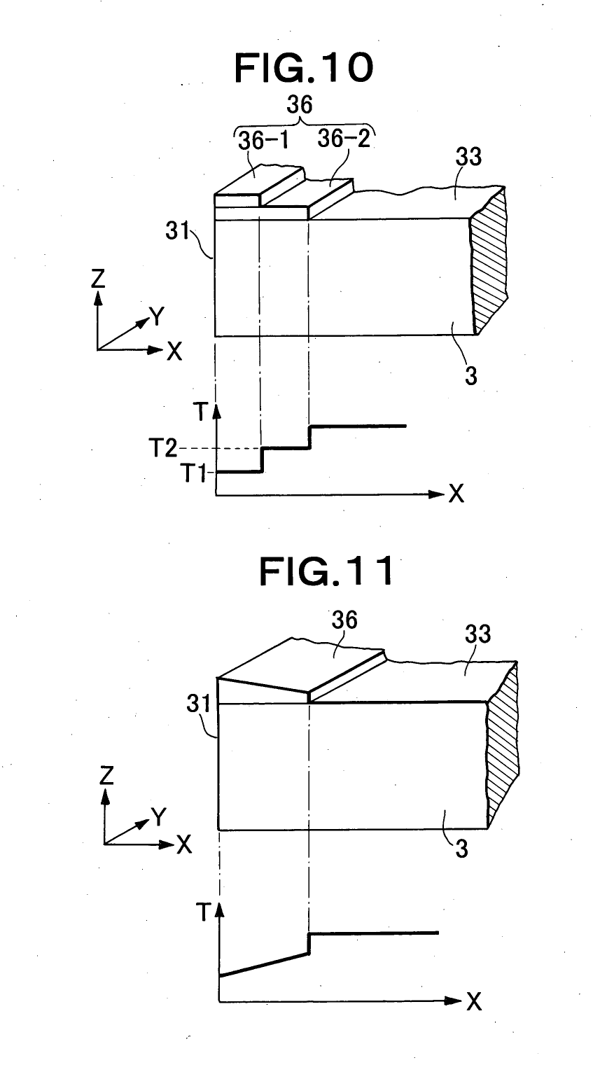

As shown in, for example, FIG. 10, the light absorption band 36 may be composed of a first region 36-1 and a second region 36-2, which is close to and far from the light incident end face, respectively, with respect to the width direction (X direction) and which are continuous to each other. The first region 36-1 may be twice as thick as the second region 36-2. Then, the second region 36-2 can have a visible light transmittance T2 higher than that T1 of the first region 36-1. The light absorption band 36, which consists of two regions of different visible light transmittances, can be formed by applying coating of a uniform thickness to both the first region 36-1 and the second region 36-2, and then applying additional coating to the first region 36-1 only. With a similar method, a light absorption band composed of three regions that differ in terms of visible light transmittance can be formed.

As FIG. 11 shows, the light absorption band 36 may be one that gradually becomes thinner in the widthwise direction (X direction) from the edge close to the light incident end face 31, toward the edge remote therefrom. Thus, this band 36 has visible light transmittance that gradually changes in the widthwise direction. This light absorption band 36 can be formed by applying coating to the light emitting face, using a mask member moving in the X direction away from the edge close to the light incident end face 31, toward the edge remote therefrom. The visible light transmittance of the light absorption band 36 need not vary over the entire width; it may vary over one part in the widthwise direction.

The visible light transmittance of the light absorption band 36 may change in a combined mode, i.e., a combination of the stepwise mode and continuous mode described with reference to FIG. 10 and FIG. 11, respectively.

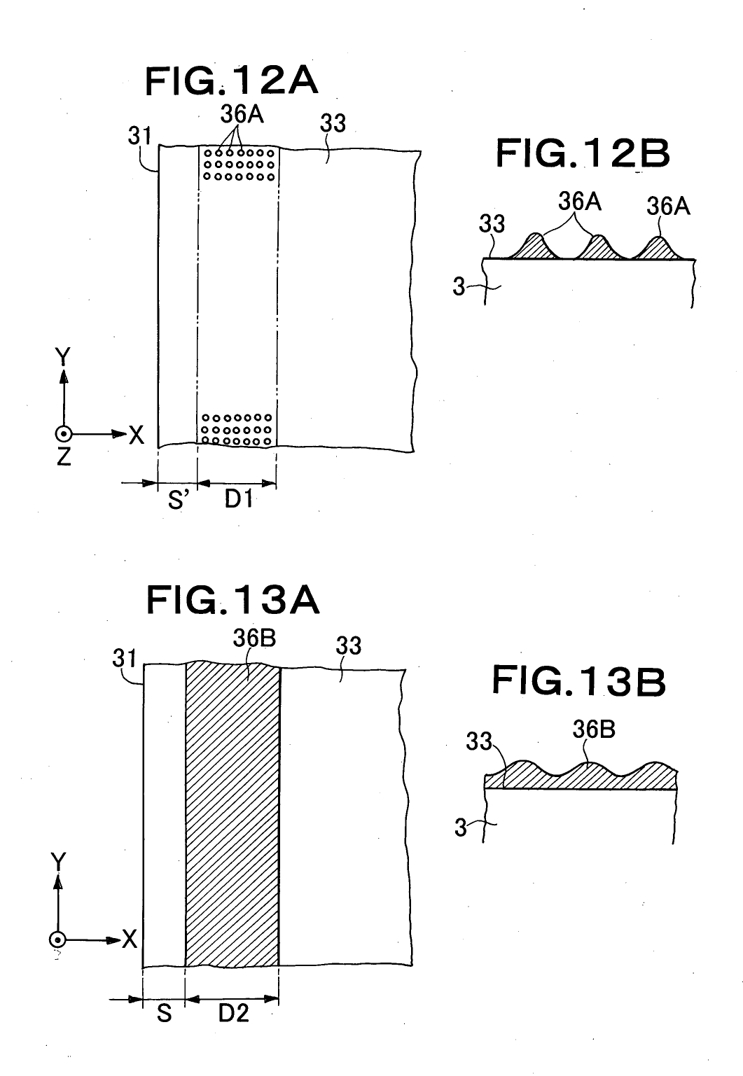

It is desired that the visible light transmittance of the light absorption band 36 should range from 0% to 60% at minimum, and from 40% to 90% at maximum. As long as the transmittance falls within these ranges, bright lines can be effectively and reliably prevented from being generated, thereby reducing non-uniformity of luminance. Another method of manufacturing such a light guide as described above will be explained, with reference to FIG. 12A, FIG. 12B, FIG. 13A and FIG. 13B. FIG. 12A and FIG. 13A are plan views showing part of the light guide. FIG. 12B and FIG. 13B are sectional views of the XZ section of the light guide.

First, as shown in FIG. 12A and 12B, ink dots 36A are formed by means of ink-jet printing, on the region having a width D1 of the light emitting face 33 of the light guide 3, which is positioned close to the light incident end face 31 and is spaced therefrom by distance S′. The ink dots 36A are independent of one another or overlap one another in part. The ink-jet printing may be carried out by using, for example, a DOD (drop-on-demand)-type printer that operates in continuous-jet (continuous spray) mode or has piezoelectric nozzles. Ink is jetted or ejected from a number of nozzles, while the light guide 3 is being moved, as needed, in a direction parallel to the light emitting face 33. Many independent ink dots 36A are thereby formed in a specific region of the light emitting face, as is illustrated in the figure. As shown in the figure, these ink dots are completely spaced from one another. They may partly overlap one another, nevertheless.

Then, the ink dots are made to combine with one another, thus providing a continuous ink layer. This process will be referred to as “leveling”. The leveling is performed for a time long enough to attain a desired leveling amount (degree). As shown in FIG. 13A and FIG. 13B, as a result, a continuous ink layer 36B is formed, covering the entire region having width D2 and spaced by distance S from the light incident end face 31. The region of width D2 includes the entire region of width D1. Thus, width D2 is a little greater than width D1.

Next, the ink layer 36B is hardened. The light absorption band 36 is thereby formed.

The ink used is, for example, ultraviolet-curable ink. Ultraviolet-curable ink is preferred, because it can easily accomplish a desired leveling amount (degree) if the timing of applying ultraviolet rays to it is well controlled. To facilitate the controlling of the timing of applying ultraviolet rays, it is desirable to maintain the ink-jet nozzles or the ink at a specific temperature. The light guide 3 may be heated, lowering the viscosity of the ink dots 36A formed by applying ink drops ejected from the nozzles. This shortens the time required for achieving a desired leveling degree, thereby shortening the time required for printing.

Thus, the leveling time is adjusted, combining the ink dots in a desired manner and forming the ink layer 36B. The undulation at the surface of the light absorption band 36 can therefore be controlled. If the light absorption band 36 has appropriate surface undulation, unnecessary light can be rendered less conspicuous. Part of the light emitted from the primary light source 1 reflected by the light source reflector 22 may reach the light absorption band 36 without reaching the light incident end face 31. In this case, most of the light is absorbed into the light absorption band 36 upon arriving at the band 36. At this time, the remaining part of the light is reflected toward the light emitting face 33 of the light guide. The light thus reflected is diffusively reflected by the undulating surface of the light absorption band 36 and is rendered less conspicuous.

The higher the resolution of the printer, the higher the density in which ink dots can be formed, and the shorter the time for attaining the desired leveling degree that achieves the combining of ink dots. It is therefore desired that the printer should have a high resolution.

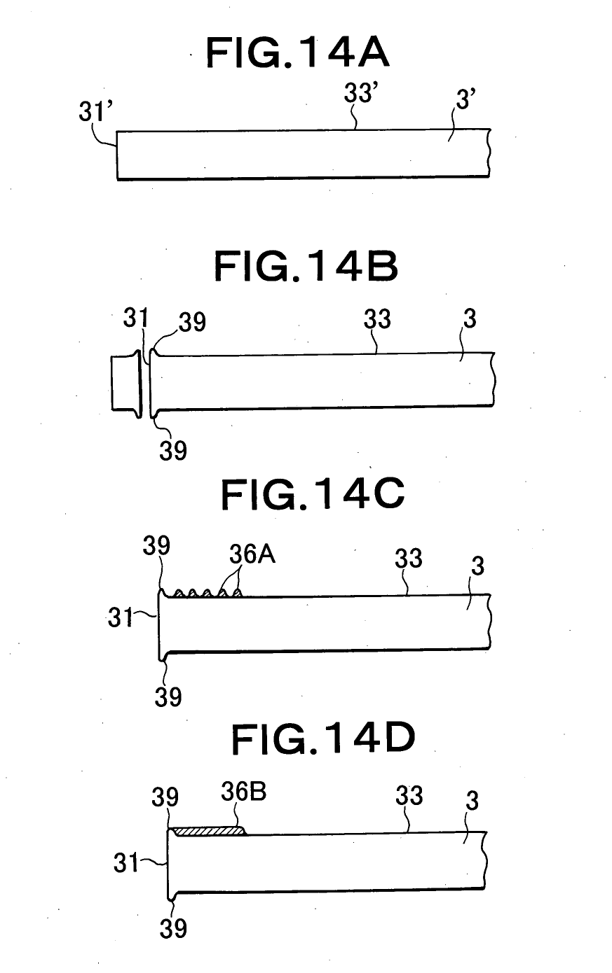

Still another method of manufacturing the light guide described above will be explained, with reference to FIGS. 14A, 14B, 14C and 14D.

In this method, a light guide blank 3′ of the type shown in FIG. 14A is prepared. As FIG. 14B shows, a shaving process is performed on the light incident face part 31′, thereby providing the light incident end face 31. The shaving process forms a projection 39 at the boundary between the light incident end face 31 and the light emitting face 33. The projection 39 projects toward the light emitting face 33 (namely, the projection 39 bulges relative to the other part of the light emitting face 33). The projection 39 extends along the boundary between the light incident end face 31 and the light emitting face 33, or along the light incident end face 31. As mentioned above, the projection 39 can be formed by shaving. Instead, it may be formed by injection molding.

Next, as shown in FIG. 14C, ink dots 36A are formed on a desired region of the light emitting face 33. They are made in such a way as has been described with reference to FIG. 12A and FIG. 12B. The ink dots are subjected to leveling. As FIG. 14D depicts, an ink layer 36B is formed in the desired region of the light emitting face 33, in such a manner as explained with reference to FIG. 13A and FIG. 13B. In this method, the region in which ink dots are to be formed is so located that the edge of the ink layer 36B, which is close to the light incident end face 31, reaches the projection 39. That is, the region in which the ink dots 36A shown in FIG. 14C will be formed is spaced a little from the light incident end face 31. The ink is therefore prevented from moving across the projection 39 to the light incident end face 31 when it flows during the process of leveling the ink dots.

Finally, the ink layer 36B is hardened. The light absorption band 36 is thereby formed.

Thus, this method can easily form the light absorption band 36 near the light incident end face 31, without making the light absorption band 36 cover the light incident end face 31. The light absorption band 36 thus formed can suppress the reduction in the amount of light introduced into the light guide 3 via the light incident end face 31.

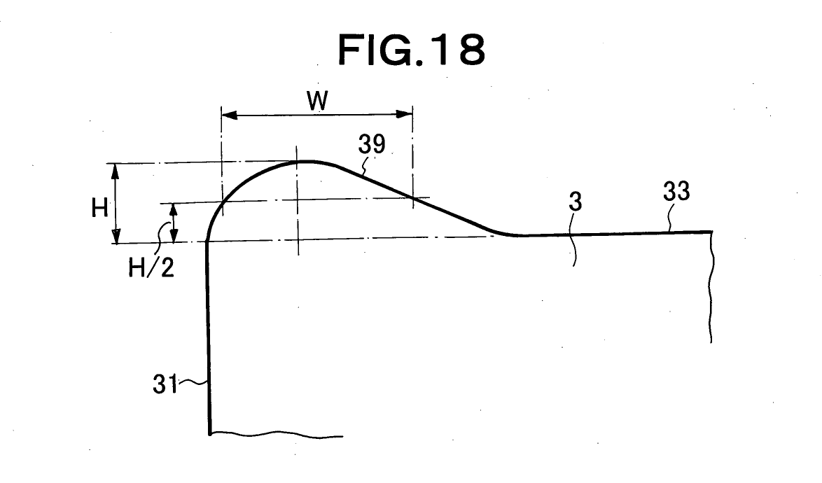

To make the projection 39 prevent the ink moving to the light incident end face 31, and to facilitate the forming of the projection 39, the projection 39 should preferably have the following dimensions. As indicated in FIG. 18, height H (measured from the other region of the light emitting face 33) of the projection 39 is preferably 1 to 50 μm, more preferably 2 to 30 μm, and much more preferably 5 to 20 μm. Full width W′ at half maximum of the height (H) of the projection 39 in the XZ-cross section is preferably 1 to 50 μm, more preferably 2 to 30 μm, and still more preferably 5 to 20 μm. If height H of the projection is too small, the ink may not be prevented well from moving. If height H is too large, it may be difficult to assemble the planer light source device, the projection 39 may easily be broken, or the ink may fail to move to a position near the top. If full width W′ at half maximum of the height (H) is too small, it may be hard to form the projection 39 and to prevent reliably the ink from moving as the mechanical strength becomes low. If the full width W′ is too large, it may be difficult to assemble the planer light source device and further the ink may fail to move to a position near the top.

In any method explained above, the ink used as paint for forming the light absorption band 36 is preferably ultraviolet-curable ink that contains (meth)acrylate monomer and/or organic solvent. This is because the light absorption band 36 formed by hardening the ink layer is bonded to the surface of the light guide 3 with an increased force. The inorganic solvent contained in the ink dissolves and roughens the surface of the light guide 3, which enhances the anchor effect. Particularly if the light guide 3 is made of (meth)acrylate resin, bridging reaction readily takes place between the ink and the light guide as the ink undergoes polymerization, because (meth)acrylate monomer exists in the ink. The bridging reaction enhances the anchor effect.

The above-mentioned (meth)acrylate monomer and organic solvent should preferably have a number average molecular weight of 100 or more, more preferably 150 or more, and still more preferably 200 or more, so that the ink concentration may not greatly change. The (meth)acrylate monomer is, for example, methyl methacrylate. In this case, the ink should preferably contain, for example, 0.5 to 10% by weight of methacrylate monomer. The organic solvent is preferably one that has a boiling point of 60° C. or more, preferably 80° C. or more, and more preferably 100° C. or more. Examples of the organic solvent are those which contain at least one element selected from the group consisting of methyl ethyl ketone, ethyl acetate, chloroform, cellosolve acetate and methacrylic acid.

The following inks can be cited as examples of such ultraviolet-curable ink:

Ink 1:
Acrylic acid oligomer: 30 to 50% by weight
Isobornyl acrylate: 10 to 20% by weight
1,6-hexanediol acrylate: 1 to 20% by weight
Tetrahydrofurfuryl-acrylate: 10 to 20% by weight
Benzophenone: 1 to 5% by weight
Carbon black: 1 to 5% by weight

Ink 2:
Isobornyl acrylate: 10 to 20% by weight
1,6-hexanediol acrylate: 1 to 20% by weight
Acrylic amine/acrylic ester mixture: 30 to 50 wt %
Benzophenone: 1 to 5% by weight
Carbon black: 1 to 5% by weight

To form the light absorption band by ink-jet printing, or the like in the present invention, the ultraviolet-curable ink should be preferably one having viscosity of 1 to 100 cp and surface tension of 20 to 55 mN/m, more preferably one having viscosity of 1 to 50 cp and surface tension of 20 to 45 mN/m, and much more preferably one having viscosity of 1 to 20 cp and surface tension of 25 to 35 mN/m. Note that the head temperature should be preferably 10 to 100° C., more preferably 35 to 85° C., and still more preferably 40 to 60° C., in consideration of the desirable leveling property of ink dots, the desired adhesiveness to the light guide, and the positioning stability of ink drops ejected.

If the light absorption band is formed by ink-jet printing, or the like, the head speed should be preferably 10 to 1000 mm/sec, more preferably 200 to 800 mm/sec, and much more preferably 250 to 500 mm/sec, in order to shorten the tact time, to increase the leveling property of ink dots and to ensure the firm bonding to the light guide.

In the present invention, the light absorption band 36 can be one that-contains fine particles of light diffusing material or light absorption material. The fine particles have a diameter of preferably 20 μm or less, more preferably 14 μm or less, and much more preferably 8 μm or less. The fine particles can be contained in an amount of 10 to 125% by weight, based on the amount of the other solid components (100 parts by weight). Examples of the light absorption fine particles are black polymer-based fine particles of acrylic resin, styrene resin, (meth)acryl/styrene copolymer resin or benzoguanamine which contain carbon black. Examples of the light diffusing fine particles are polymer-based particles of acrylic resin, styrene resin or (meth)acryl/styrene copolymer resin or silicone resin, or inorganic particles of silica, alumina, calcium carbonate or the like. The light diffusing fine particles may be those which utilize the light diffusion resulting from the surface reflection or those which are transparent to light and which utilize the light diffusion resulting from the refraction of light transmitted. The light absorption fine particles help to improve the light absorption band 36 in terms of the light absorption property. The light diffusing fine particles diffuses light in the light absorption band 36, indirectly enhancing the light absorption property, and also helps to diffuse the light not absorbed and eventually emitted, thus increasing the luminance uniformity.

FIG. 15 illustrates an embodiment of a light absorption band 36 containing either light diffusing fine particles or light absorption fine particles. This light absorption band 36 has tiny convexes and concaves on the surface. The convexes 37 are formed by some of the light diffusing fine particles or light absorption fine particles contained in the light absorption band 36. The convexes and concaves are formed as a layer or film of paint is formed after the light diffusing or light absorbing particles have been mixed into the paint. The tiny convexes and concaves, thus formed on the surface of the band 36, make unnecessary light less conspicuous. That is, if part of the light emitted from the primary light source 1 is reflected by the light source reflector 22 and reaches the light absorption band 36 without reaching the light incident end face 31, it will almost be absorbed into the light absorption band 36, as described above. The remaining part of this light is reflected toward the light emitting face 33 of the light guide. The light thus reflected is diffused and reflected by the convexes and concaves provided on the surface of the light absorption band 36. This is why this light is made not conspicuous.

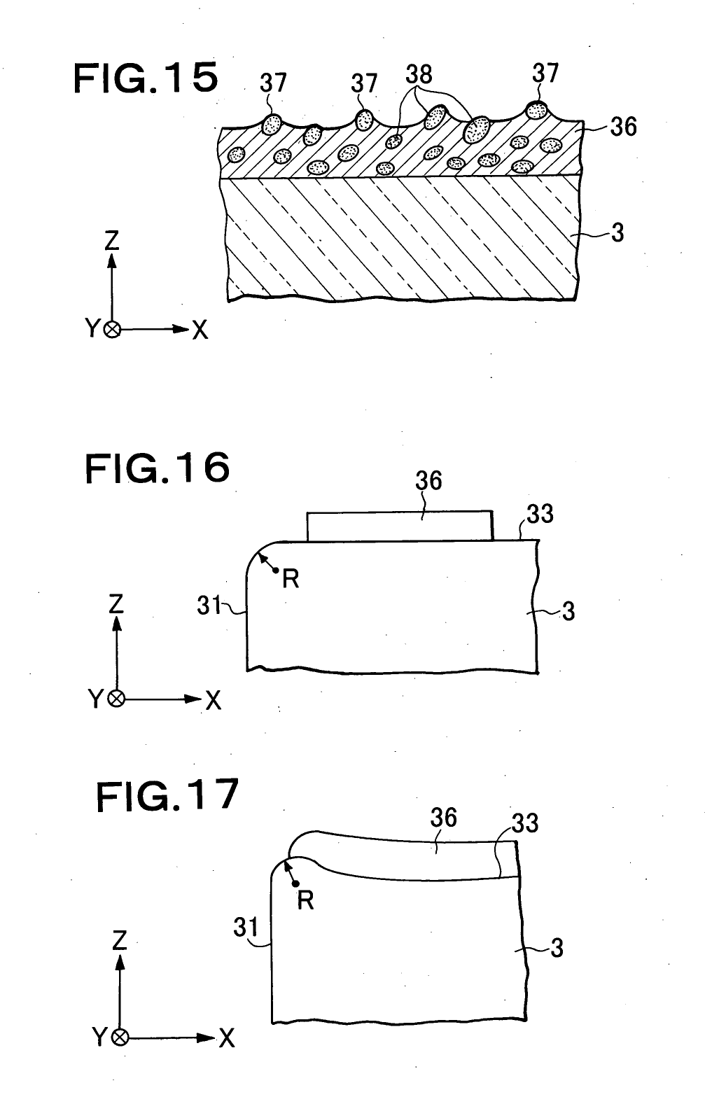

FIG. 16 is a magnified view of the boundary between the light emitting face 33 and light incident end face 31 of the light guide 3. It is desired that the edge part, which defines the boundary between the light emitting face 33 and the light incident end face 31, be a right-angled one. In practice, however, the edge part is rounded as the manufacturing process goes on. In many cases, it is a curved surface having a small radius of curvature. In particular, if the light incident end face 31 is formed by a shaving process as described above, the light guide made of synthetic resin melts in part. Then, the edge part at the boundary between the light emitting face 33 and the light incident end face 31 may become curved, due to surface tension. The radius R of curvature of the edge part should be preferably 50 μm or less, in order to prevent reduction in luminance uniformity so that bright lines may not appear. If the radius R of curvature is too large, much light enters at the edge part, which acts like a convex lens. Consequently, the light guide 3 may emit abnormal light, or the light absorption band 36 may not prevent the generation of bright lines so much as is expected. The edge part should have a radius R of curvature, which is preferably 10 μm or less, and more preferably 5 μm or less.

FIG. 17 is a magnified view of the boundary between a light emitting face 33 and a light incident end face 31. These faces 33 and 31 have been formed at the same time, by performing a shaving process on the light absorption band 36 and the part of the light incident end face 31 which is close to the light incident end face. Because of the surface tension, the edge part at the boundary between the light emitting face 33 and the light incident end face 31 has a curved surface (corresponding to a projection 39 described above) that has a radius R of curvature. One edge of the light absorption band 36 is located, exposing a part of the edge of the light guide. The exposed part of the edge constitutes the light incident end face 31 of the light guide.

The present invention will be described, with reference to some examples.

### EXAMPLES 1 TO 9 AND COMPARATIVE EXAMPLES 1 TO 3

A rectangular, wedge-shaped light guide blank was prepared by injection molding of acrylic resin (Acrypet [tradename], available from Mitsubishi Rayon Co., Ltd.). The blank was one having a mat-finished surface on one surface and elongated prisms on the other surface. The elongated prisms were arranged at pitch of 50 μm, extending parallel to the shorter sides of the light guide blank, defining a prism pattern. Each elongated prism was one having an apex angle of 100 degrees and a radius of curvature of 15 μm at the apex. Black ink identified below was applied by screen printing to the mat-finished surface of the light guide blank, forming light absorption band parts arranged in an area adjacent to the longer side of the light guide blank having a greater thickness, so that light absorption band parts were ones having various widths (Thus, Examples 1 to 9 and Comparative Examples 1 to 3 were formed). In a similar method, the black ink was applied to a transparent acrylic resin plate having a thickness of 2 mm, thus forming an ink layer. This ultraviolet-curable black ink was printed in such a size as can be easily examined for visible light transmittance. The ink exhibited a visible light transmittance of 40%.

Black Ink
Acrylic acid oligomer: 45% by weight
Isobornyl acrylate: 17% by weight
1,6-hexanediol acrylate: 15% by weight
Tetrahydrofurfuryl acrylate; 15% by weight
Benzophenone: 3% by weight
Carbon black: 5% by weight

Next, a shaving process was carried out on light incident end face parts of the light guide blanks, removing unnecessary parts including those fractional sections of the light absorption band parts. Light guides were thereby obtained, each having a light incident end face that had been made by the shaving process. The light guides thus obtained were wedge-shaped, measuring 230 mm×290 mm and having a thickness of 2.2 mm to 0.7 mm. Their edge parts were ones having a radius R of curvature of 40 μm. The light absorption band of each light guide was spaced by 0 μm from the light incident end face, and the width of each light guide was that specified below:

### EXAMPLE 1

800 μm

### EXAMPLE 2

700 μm

### EXAMPLE 3

600 μm

### EXAMPLE 4

500 μm

### EXAMPLE 5

400 μm

### EXAMPLE 6

300 μm

### EXAMPLE 7

200 μm

### EXAMPLE 8

150 μm

### EXAMPLE 9

75 μm

### COMPARATIVE EXAMPLE 1

20 μm

### COMPARATIVE EXAMPLE 2

1500 μm

### COMPARATIVE EXAMPLE 3

20 μm (with an additional, 20-μm wide light absorption band formed on the light incident end face so as to be in contact with the-above light absorption band on the light emitting face)

A cold cathode tube was arranged along the end face of each light guide, which corresponds to one of the sides of the light guide that were 290 mm long (and 2.2 mm thick), and covered with a light source reflector (silver reflection film available from Reikosha Co., Ltd.). Further, a diffusive reflection film (E60: tradename, available from Toray Industries, Inc.) was bonded to the other end faces, and a reflection sheet was arranged so as to face the surface (back surface) on which the elongated prisms were arranged. The above-described structure was put into a corresponding frame. The resultant structure was set in a frame, thereby providing a light guide. The light guide exhibited the luminous intensity distribution of emitted light (in the XZ plane) in which the angle of peak luminous intensity was 70 degrees with respect to the normal to the light emitting face, and the full width at half maximum was 22.5 degrees.

A prism sheet was prepared by forming many elongated prisms on one surface of a polyester film having a thickness of 125 μm. The elongated prisms were made of acrylic ultraviolet-curable resin with the refractive index of 1.5064 and juxtaposed at a pitch of 50 μm. Each elongated prism was one having a convex prism face of a radius of curvatures of 1000 μm and a planar prism face.

The prism sheet thus prepared was positioned, with the prism-formed surface opposed to the light emitting face (mat-finished surface) of the light guide, with the ridges of the elongated prisms extending parallel to the light incident end face of the light guide, and with the planar prism face of each elongated prism located on the side of the light incident end face of the light guide.

The planer light source devices according to Examples 1 to 9 and Comparative Examples 1 to 3, thus prepared, were tested. More precisely, the primary light source was lighted in each device and the light emitting surface was subjected to visual observation. In Examples 1 to 9, blight lines were scarcely seen near the light incident end face, and dark lines were scarcely seen in the display area. In Comparative Example 1, bight lines were clearly observed in the vicinity of the light incident end face of the light guide. In Comparative Example 2, the brightness was lower near the light incident end face than in Examples 1 to 9. In Comparative Example 3, the brightness was lower than in Examples 1 to 9, and dark lines were seen in the display area.

### EXAMPLE 10

A light guide blank was made in the same way as in Example 1. A shaving process was performed on the light incident end face part of the light guide blank to form a light incident end face. A light guide was thereby obtained, which has a light incident end face made by the shaving process. The light guide was a wedge-shaped one, measuring 230 mm×290 mm and having a thickness of 2.2 mm to 0.7 mm. Many drops of the ultraviolet-curable black ink identified below were applied to the mat-finished surface of the light guide having the prism pattern, by means of ink-jet printing carried out in the conditions specified below. Many ink dots of the diameter of 100 μm, which were independent of one another, were thereby formed on the mat-finished surface. As FIG. 12A and FIG. 12B show, the ink dots lay in a region having width D1 of about 300 μm and spaced by distance S′ of about 60 μm. The ink dots were subjected to leveling for 5 seconds, whereby a continuous ink layer was formed as illustrated in FIG. 13A and FIG. 13B, in a region having width D2 of about 400 μm and spaced by distance S of about 10 μm. At that time, ultraviolet rays were applied, curing the ink layer. As a result, a light absorption band, almost linear, was formed.

Ink-Jet Printing
Head speed: 400=mm/sec
Head temperature: 55° C.
Ink-applying pressure: built by piezoelectric-element

Black Ink
Ultraviolet-curable black ink (95 wt % of ink+5 wt % of methyl methacrylate)

Ink Composition
Acrylic acid oligomer: 42% by weight
Isobornyl acrylate: 15% by weight
1,6-hexanediol acrylate: 20% by weight
Acrylic amine/acrylic ester mixture: 15% by weight
Benzophenone: 3% by weight
Carbon black: 5% by weight

Viscosity of Ink (at 55° C.): 10 cp

Surface Tension of Ink (at 55° C.): 30 mN/m

In a similar method, the ultraviolet-curable black ink was applied to a transparent acrylic resin plate having a thickness of 2 mm, thus forming an ink layer. This ultraviolet-curable black ink was printed in such a size as can be easily examined for visible light transmittance. The ink exhibited a visible light transmittance of 20%.

As in Example 1, the light guide thus obtained was combined with a cold cathode tube, a light source reflector, a diffusive reflection film and a reflection sheet. A structure is thereby obtained. The resultant structure was set in a frame. The light guide exhibited the luminous intensity distribution of emitted light (in the XZ plane) in which the angle of peak luminous intensity was 70 degrees with respect to the normal to the light emitting face, and the full width at half maxim was 22.5 degrees.

The prism sheet prepared in the same way as in Example 1 was positioned, with the prism-formed surface opposed to the light emitting face (mat-finished surface) of the light guide, with the ridges of the elongated prisms extending parallel to the light incident end face of the light guide, and with the planar prism face of each elongated prism located on the side of the light incident end face of the light guide.

The planer light source device thus obtained was tested. More precisely, the primary light source was lighted in the device and the light emitting surface was subjected to visual observation. Blight lines were scarcely seen near the light incident end face, and dark lines were scarcely recognized in the display area.

### COMPARATIVE EXAMPLE 4

A light guide blank was made in the same way as in Example 1. A shaving process was performed on the light incident end face part of the light guide blank to form a light incident end face. A light guide was thereby obtained, which has a light incident end face made by the shaving process. In this comparative example, no light absorption band was formed.

As in Example 1, the light guide thus obtained was combined with a cold cathode tube, a light source reflector, a diffusive reflection film and a reflection sheet. A structure is thereby obtained. The resultant structure was set in a frame. The light guide exhibited the luminous intensity distribution of emitted light (in the XZ plane) in which the angle of peak luminous intensity was 70 degrees with respect to the normal to the light emitting face, and the full width at half maximum was 22.5 degrees.

The prism sheet prepared in the same way as in Example 1 was positioned, with the prism-formed surface opposed to the light emitting face (mat-finished surface) of the light guide, with the ridges of the elongated prisms extending parallel to the light incident end face of the light guide, and with the planar prism face of each elongated prism located on the side of the light incident end face of the light guide.

The planer light source device thus obtained was tested in the same conditions as Example 10. More precisely, the primary light source was lighted in the device and the light emitting surface was subjected to visual observation. Blight lines were clearly seen near the light incident end face of the light guide.

### EXAMPLE 11

A light guide blank was made in the same way as in Example 1. A shaving process was performed on the light incident end face part of the light guide blank to form a light incident end face. A light guide was thereby obtained, which has a light incident end face made by the shaving process. The light guide was a wedge-shaped one, measuring 230 mm×290 mm and having a thickness of 2.2 mm to 0.7 mm. Many drops of the ultraviolet-curable black ink were applied to the mat-finished surface of the light guide having the prism pattern, by means of ink-jet printing carried out in the same way as in Example 10. Many ink dots of the diameter of 100 μm, which were independent of one another, were thereby formed on the mat-finished surface. As FIG. 12A and FIG. 12B show, the ink dots lay in a region having width D1 of about 300 μm and spaced by distance S′ of about 60 μm. Ultraviolet rays were applied immediately thereafter, not subjecting the ink dots to leveling. The ink dots were thereby cured, forming an almost linear light absorption band. This light absorption band consisted of ink dots positioned independently of one another. The band had a width of about 300 μm and was spaced from the light incident end face by a distance of about 60 μm.

In a similar method, the ultraviolet-curable black ink was applied to a transparent acrylic resin plate having a thickness of 2 mm, thus forming an ink layer. This ultraviolet-curable black ink was printed in such a size as can be easily examined for visible light transmittance. The ink exhibited a visible light transmittance of 20%.

As in Example 1, the light guide thus obtained was combined with a cold cathode tube, a light source reflector, a diffusive reflection film and a reflection sheet. A structure is thereby obtained. The resultant structure was set in a frame. The light guide exhibited the luminous intensity distribution of emitted light (in the XZ plane) in which the angle of peak luminous intensity was 70 degrees with respect to the normal to the light emitting face, and the full width at half maximum was 22.5 degrees.

The prism sheet prepared in the same way as in Example 1 was positioned, with the prism-formed surface opposed to the light emitting face (mat-finished surface) of the light guide, with the ridges of the elongated prisms extending parallel to the light incident end face of the light guide, and with the planar prism face of each elongated prism located on the side of the light incident end face of the light guide.

The planer light source device thus obtained was tested in the same conditions as Example 10. More precisely, the primary light source was lighted in the device and the light emitting surface was subjected to visual observation. The luminance was slightly lower than in Example 10, and a few blight lines were observed near the light incident end face.

### EXAMPLE 12

As in Example 10, a shaving process was performed on the light incident end face part of the light guide blank to form a light incident end face, thereby providing a light guide that has a light incident end face made by the shaving process. As the shaving process proceeds, a projection protruding relative to another region of the light emitting face, at the boundary between the light incident end face and the light emitting face. The projection had a height of 10 μm and a full width of 10 μm at half maximum of the height. As in Example 10, ink dots were formed and subjected to leveling, thereby forming an ink layer. The region in which the ink dots were formed was so positioned that the ink layer reached the projection during the leveling.

The planer light source device obtained in the same manner as Example 10, except that the light guide obtained in the above was used, was tested. That is, the primary light source was lighted in the device and the light emitting surface was subjected to visual observation. Blight lines were scarcely seen near the light incident end face, and dark lines were scarcely recognized in the display area.

What is claimed is:

1. A light guide for use in planar light source devices, which guides light emitted from a primary light source, comprising:
a light incident end face for receiving the light emitted from the primary light source;
a light emitting face for emitting the light guided in the light guide; and
a light absorption band provided on the light emitting face,
wherein the light absorption band extends along the light incident end face and has a width of 50 μm to 1000 μm, and an edge of the light absorption band which is positioned close to the light incident end face is at a distance of 300 μm or less from the light incident end face.

2. The light guide for use in planar light source devices as claimed in claim 1, wherein the visible light transmittance of the light absorption band gradually increases from the side near the light incident end face toward the side remote from the light incident end face.

3. The light guide for use in planar light source devices as claimed in claim 1, wherein the light absorption band has minute convexes and minute concaves on a surface thereof.

4. The light guide for use in planar light source devices as claimed in claim 1, wherein the edge part defining a boundary between the light emitting face and the light incident end face has a radius of curvature of 50 μm or less.

5. The light guide for use in planar light source devices as claimed in claim 1, wherein the edge part defining a boundary between the light emitting face and the light incident end face is formed as a projection which extends along the light incident end face and projects relative to another region of the light emitting face, and the projection has a height of 1 to 50 μm as measured from the light emitting face.

6. The light guide for use in planar light source devices as claimed in claim 1, wherein the edge part defining a boundary between the light emitting face and the light incident end face is formed as a projection which extends along the light incident end face and projects relative to another region of the light emitting face, and the projection has a full width at half maximum of the height of 1 to 50 μm.

7. A method of manufacturing a light guide for use in planar light source devices, comprising the steps of:
forming a light absorption band part on a light emitting face part of a light guide blank at least in a region adjacent to a light incident end face part; and
performing a shaving process on the light incident end face part, thereby forming the light incident end face.

8. The method of manufacturing a light guide for use in planar light source devices as claimed in claim 7, wherein the light absorption band part is formed by applying ink.

9. A method of manufacturing a light guide for use in planar light source devices, comprising the steps of:
jetting ink from a plurality of nozzle by an ink jet printing method to form ink dots independent of one another or continuous in part to one another on a light emitting face of the light guide at least at a region adjacent to a light incident end face of the light guide;.
combining the ink dots which are close to one another, thereby forming a continuous ink layer on the entirety of the region; and
curing the ink layer, thereby forming a light absorption band.

10. The method of manufacturing a light guide for use in planar light source devices as claimed in claim 9, wherein a shaving process is carried out on a light incident end face part of the light guide blank, thereby forming the light incident end face, and the light absorption band is formed thereafter.

11. The method of manufacturing a light guide for use in planar light source devices as claimed in claim 10, wherein the edge of the ink layer which is close to the light incident end face reaches a projection made during the shaving process and protruding from the light emitting face.

12. The method of manufacturing a light guide for use in planar light source devices as claimed in claim 8 or 9, wherein the ink is ultraviolet-curable ink containing (meth)acrylate monomer and/or organic solvent.

13. The method of manufacturing a light guide for use in planar light source devices as claimed in claim 12, wherein the (meth)acrylate monomer and/or organic solvent has a number average molecular weight of 100 or more.

14. The method of manufacturing a light guide for use in planar light source devices as claimed in claim 12, wherein the (meth)acrylate monomer is methyl methacrylate.

15. The method of manufacturing a light guide for use in planar light source devices as claimed in claim 12, wherein the (meth)acrylate monomer is contained in the ink at an amount of 0.5 to 10% by weight.

16. The method of manufacturing a light guide for use in planar light source devices as claimed in claim 12, wherein the organic solvent has a boiling point of 60° C. or more.

17. The method of manufacturing a light guide for use in planar light source devices as claimed in claim 12, wherein the organic solvent includes at least one element selected from the group consisting of methyl ethyl ketone, ethyl acetate, chloroform, cellosolve acetate and methacrylic acid.

18. A planer light source device comprising:
a light guide designed for use in planer light source devices according to any one of claims 1 to 6;
a primary light source arranged adjacent to the light incident end face of the light guide; and
a light deflector element arranged adjacent to the light emitting face of the light guide,
wherein the light deflector element has a light receiving surface and a light emitting surface opposed to the light receiving surface, and has a plurality of elongated prisms arranged on the light receiving surface and extending in parallel to one another and substantially in parallel to the light incident end face of the light guide.

19. The planer light source device as claimed in claim 18, wherein a light diffusing element is arranged adjacent to the light emitting surface of the light deflector element, the light diffusing element has a dot-pattern region on which a pattern of light absorption dots is provided, the dot-pattern region has a width within which is included at least a region located between two positions at a distance of 2 mm and another distance of 4 mm, respectively, from the light incident end face of the light guide, and the dot-pattern region has distributed dots of light absorption paint which have a diameter ranging from 30 μm to 70 μm.
